(19) United States
(12) Patent Application Publication
(10) Pub. No.: US 2007/0005842 A1
(43) Pub. Date: Jan. 4, 2007

(54) SYSTEMS AND METHODS FOR STALL MONITORING

(75) Inventors: Oliver P. Sohm, Toronto (CA); Gary L. Swoboda, Sugar Land, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/383,472

(22) Filed: May 15, 2006

Related U.S. Application Data
(60) Provisional application No. 60/681,427, filed on May 16, 2005.
(60) Provisional application No. 60/681,497, filed on May 16, 2005.

(51) Int. Cl. G06F 13/38

(52) U.S. Cl. 710/62

(57) ABSTRACT

Stall monitoring systems and methods are disclosed. Exemplary stall monitoring systems may include a core, a memory coupled to the core, and a stall circuit coupled to the core. The stall circuit is capable of separately representing at least two distinct stall conditions that occur simultaneously and conveying this information to a user for debugging purposes.

### CROSS-REFERENCE TO RELATED APPLICATIONS

The application claims the benefit of U.S. Provisional Application Ser. No. 60/681,497 filed May 16, 2005, titled “Emulation/Debugging with Real-Time System Monitoring,” and U.S. Provisional Application Ser. No. 60/681,427 filed May 16, 2005, titled “Debugging Software-Controlled Cache Coherence,” both of which are incorporated herein by as if reproduced in full below.

This application also may contain subject matter that may relate to the following commonly assigned co-pending applications incorporated herein by reference: “Real-Time Monitoring, Alignment, and Translation of CPU Stalls or Events,” Ser. No.______, filed May 12, 2006, Attorney Docket No. TI-60586 (1962-31400); “Event and Stall Selection,” Ser. No.______, filed May 12, 2006, Attorney Docket No. TI-60589 (1962-31500); “Watermark Counter With Reload Register,” filed May 12, 2006, Attorney Docket No. TI-60143 (1962-32700); “Real-Time Prioritization of Stall or Event Information,” Ser. No.______, filed May 12, 2006, Attorney Docket No. TI-60647 (1962-33000); “Method of Translating System Events Into Signals For Activity Monitoring,” Ser. No.______, filed May 12, 2006, Attorney Docket No. TI-60649 (1962-33100); “Monitoring of Memory and External Events,” Ser. No.______, filed May 12, 2006, Attorney Docket No. TI-60642 (1962-34300); “Event-Generating Instructions,” Ser. No.______, filed May 12, 2006, Attorney Docket No. TI-60659 (1962-34500); and “Selectively Embedding Event-Generating Instructions,” Ser. No.______,filed May 12, 2006, Attorney Docket No. TI-60660 (1962-34600).

### BACKGROUND

Integrated circuits are ubiquitous in society and can be found in a wide array of electronic products. Regardless of the type of electronic product, most consumers have come to expect greater functionality when each successive generation of electronic products are made available because successive generations of integrated circuits offer greater functionality such as faster memory or microprocessor speed. Moreover, successive generations of integrated circuits that are capable of offering greater functionality are often available relatively quickly. For example, Moore's law, which is based on empirical observations, predicts that the speed of these integrated circuits doubles every eighteen months. As a result, integrated circuits with faster microprocessors and memory are often available for use in the latest electronic products every eighteen months.

Although successive generations of integrated circuits with greater functionality and features may be available every eighteen months, this does not mean that they can then be quickly incorporated into the latest electronic products. In fact, one major hurdle in bringing electronic products to market is ensuring that the integrated circuits, with their increased features and functionality, perform as expected. Generally speaking, ensuring that the integrated circuits will perform their intended functions when incorporated into an electronic product is called “debugging” the electronic product. The amount of time that debug takes varies based on the complexity of the electronic product. One risk associated with debug is that the debugging process delays the product from being introduced into the market.

To prevent delaying the electronic product because of delay in debugging the integrated circuits, software based simulators that model the behavior of the integrated circuit to be debugged are often developed so that debugging can begin before the integrated circuit is actually available. While these simulators may have been adequate in debugging previous generations of integrated circuits, such simulators are increasingly unable to accurately model the intricacies of newer generations of integrated circuits. Specifically, these simulators are not always able to accurately model events that occur in integrated circuits that incorporate cache memory. Further, attempting to develop a more complex simulator that copes with the intricacies of debugging integrated circuits with cache memory takes time and is usually not an option because of the preferred short time-to-market of electronic products. Unfortunately, a simulator's inability to effectively model cache memory events results in the integrated circuits being employed in the electronic products without being optimized to their full capacity.

### SUMMARY

Stall monitoring systems and methods are disclosed. Exemplary stall monitoring systems include a core, a memory coupled to the core, and a stall circuit coupled to the core. The stall circuit is capable of separately representing at least two distinct stall conditions that occur simultaneously and conveying this information to a user for debugging purposes.

Other embodiments include a method of monitoring stall cycles that includes tracking a program counter (PC) value associated with an instruction that has been executed, observing a number of elapsed cycles at the conclusion of the instruction's execution (wherein a stall occurs if the instruction's execution consumed more than the number of cycles associated with a single, unimpeded execution of the instruction), and interpreting a concurrent stall conflict signal if a stall has occurred. The concurrent stall conflict signal is capable of separately representing at least two distinct stall conditions that occur simultaneously.

Yet further embodiments include a computer program embodied in a tangible medium, the instructions of the program including the acts of tracking a value for a program counter (PC) of a processor executing instructions, observing a number of elapsed cycles by the processor, interpreting a plurality of concurrent stall signals, and providing a user with information regarding at least two distinct stall conditions that occur.

Still other embodiments include a stall circuit capable of interfacing with a core, wherein the stall circuit represents at least two distinct stall conditions that occur simultaneously within the core, and wherein the stall circuit is capable of providing separate representations of the at least two distinct stall conditions to locations other than the core.

### BRIEF DESCRIPTION OF THE DRAWINGS

For a detailed description of exemplary embodiments of the invention, reference will now be made to the accompanying drawings in which:

FIG. 1 depicts an exemplary debugging system;

FIG. 2 depicts an exemplary embodiment of the circuitry being debugged;

FIG. 3 depicts exemplary hardware that may be used to provide specialized stall signals for the circuitry being debugged;

FIG. 4A depicts an exemplary output from debugging software;

FIG. 4B depicts an exemplary output from debugging software with custom stall information available; and

FIG. 5 depicts an exemplary algorithm.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical or optical connection, or through an indirect electrical or optical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Systems and methods are disclosed for optimizing integrated circuitry (IC) operation. More specifically, the disclosed systems and methods allow integrated circuits to be debugged during operation of the integrated circuit and also allow greater insight into hierarchical memory systems such as memory systems with cache memory, physical memory, as well as peripheral storage devices.

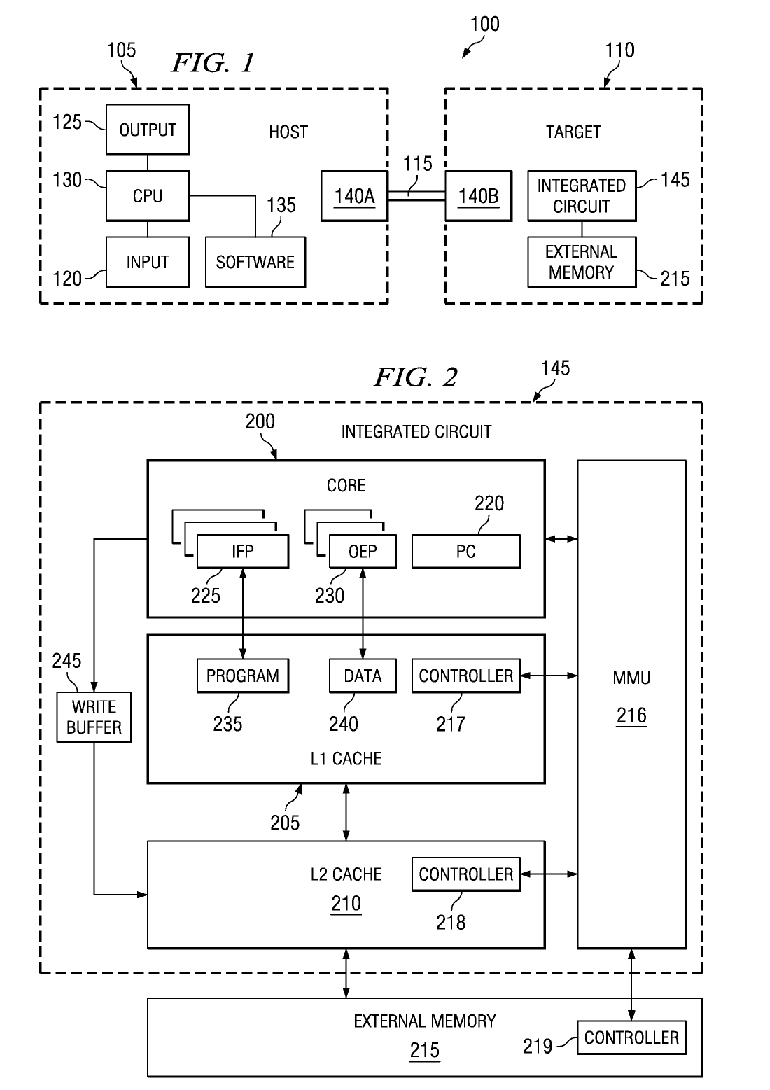

FIG. 1 depicts an exemplary debugging system 100 including a host computer 105 coupled to a target device 110 through a connection 115. A user may debug the target device 110 by operating the host computer 105. To this end, the host computer 105 may include an input device 120, such as a keyboard or mouse, as well as an output device 125, such as a monitor or printer. Both the input device 120 and the output device 125 couple to a central processing unit 130 (CPU) that is capable of receiving commands from a user and executing debugging software 135 accordingly.

Connection 115 may be a wireless, hard-wired, or optical connection. In the case of a hard-wired connection, connection 115 is preferably implemented in accordance with any suitable protocol such as a JTAG (which stands for Joint Testing Action Group) type of connection. Additionally, hard-wired connections may include real time data exchange (RTDX) types of connection developed by Texas Instruments, Inc. Briefly put, RTDX gives system developers continuous real-time visibility into the applications that are being developed on the target 110 instead of having to force the application to stop, via a breakpoint, in order to see the details of the application execution. Both the host 105 and the target 110 may include interfacing circuitry 140A-B to facilitate implementation of JTAG, RTDX, or other interfacing standards.

The software 135 interacts with the target 110 and may allow the debugging and optimization of applications that are being executed on the target 110. More specific debugging and optimization capabilities of the target 110 and the software 135 will be discussed in more detail below.

The target 110 preferably includes the circuitry 145 executing firmware code being actively debugged. In some embodiments, the target 110 preferably is a test fixture that accommodates the circuitry 145 when code being executed by the circuitry 145 is being debugged. This debugging may be completed prior to widespread deployment of the circuitry 145. For example, if the circuitry 145 is eventually used in cell phones, then the executable code may be debugged and designed using the target 110.

The circuitry 145 may include a single integrated circuit or multiple integrated circuits that will be implemented as part of an electronic device. For example, in some embodiments the circuitry 145 includes multi-chip modules comprising multiple separate integrated circuits that are encapsulated within the same packaging. Regardless of whether the circuitry 145 is implemented as a single-chip or multi-chip module, the circuitry 145 may eventually be incorporated into electronic devices such as cellular telephones, portable gaming consoles, network routing equipment, or computers.

FIG. 2 illustrates an exemplary embodiment of the circuitry 145 including a processor core 200 coupled to a first level cache memory (L1 cache) 205 and also coupled to a second level cache memory (L2 cache) 210. In general, cache memory is a location for retrieving data that is frequently used by the core 200. Further, the L1 and L2 caches 205 and 210 are preferably integrated on the circuitry 145 in order to provide the core 200 with relatively fast access times when compared with an external memory 215 that is coupled to the core 200. The external memory 215 is preferably integrated on a separate semiconductor die than the core 200. Although the external memory 215 may be on a separate semiconductor die than the circuitry 145, both the external memory 215 and the circuitry 145 may be packaged together, such as in the case of a multi-chip module. Alternatively, in some embodiments, the external memory 215 may be a separately packaged semiconductor die.

The L1 and L2 caches 205 and 210 as well as the external memory 215 each include a memory controller 217, 218, and 219 respectively. The circuitry 145 of FIG. 1 also comprises a memory management unit (MMU) 216 which couples to the core 200 as well as the various levels of memory as shown. The MMU 216 interfaces between memory controllers 217, 218, and 219 for the L1 cache 205, the L2 cache 210, and the external memory 215 respectively. Other embodiments may not implement virtual memory addressing, and thus do not include a memory management unit, and all such embodiments, both with and without memory management units, are intended to be within the scope of the present disclosure.

Since the total area of the circuitry 145 is preferably as small as possible, the area of the L1 cache 205 and the L2 cache 210 may be optimized to match the specific application of the circuitry 145. Also, the L1 cache 205 and/or the L2 cache 210 may be dynamically configured to operate as non-cache memory in some embodiments.

Each of the different memories depicted in FIG. 2 may store at least part of a program (comprising multiple instructions) that is to be executed on the circuitry 145. As one of ordinary skill in the art will recognize, an instruction refers to an operation code or “opcode” and may or may not include objects of the opcode, which are sometimes called operands.

Once an instruction is fetched from a memory location, registers within the core 200 (not specifically represented in FIG. 2) temporarily store the instruction that is to be executed by the core 200. A program counter (PC) 220 preferably indicates the location, within memory, of the next instruction to be fetched for execution. In some embodiments, the core 200 is capable of executing portions of the multiple instructions simultaneously, and may be capable of pre-fetching and pipelining. Pre-fetching involves increasing execution speed of the code by fetching not only the current instruction being executed, but also subsequent instructions as indicated by their offset from the PC 220. These prefetched instructions may be stored in a group of registers arranged as an instruction fetch pipeline 225 (IFP) within the core 200. As the instructions are pre-fetched into the IFP 225, copies of each instruction's operands (to the extent that the opcode has operands) also may be fetched into an operand execution pipeline (OEP) 230.

One goal of pipelining and pre-fetching instructions and operands is to have the core 200 complete the instruction on its operands in a single cycle of the system clock. A pipeline “stall” occurs when the desired opcode and/or its operands is not in the pipeline and ready for execution when the core 200 is ready to execute the instruction. In practice, stalls may result for various reasons such as the core 200 waiting to be able to access memory, the core 200 waiting for the proper data from memory, data not present in a cache memory (a cache “miss”), conflicts between resources attempting to access the same memory location, etc.

Implementing memory levels with varying access speeds (i.e., caches 205 and 210 versus external memory 215) generally reduces the number of stalls because the requested data may be more readily available to the core 200 from L1 or L2 cache 205 and 210 than the external memory 215. Additionally, stalls may be further reduced by segregating the memory into a separate program cache (for instructions) and a data cache (for operands) such that the IFP 225 may be filled concurrently with the OEP 230. For example, the L1 cache 205 may be segregated into an L1 program cache (L1P) 235 and an L1 data cache (L1D) 240, which may be coupled to the IFP 225 and OEP 230 respectively. In the embodiments that implement L1P 235 and L1D 240, the controller 217 may be segregated into separate memory controller for the L1P 235 the L1D 240. A write buffer 245 also may be employed in the circuitry 145 so that the core 200 may write to the write buffer 245 in the event that the memory is busy, to prevent the core 200 from stalling.

The example of FIG. 2 implements a write-back cache, and any write of data not within the next lower level of cache (e.g., the L1 cache in FIG. 1) is inserted into write buffer 245. Once the data is written to write buffer 245, core 200 continues processing other instructions while write buffer 245 is emptied into L2 cache 210, bypassing L1 cache 205. Thus, core 200 only stalls on write misses to L1 cache 205 when write buffer 245 is full. Write buffer 245 fills up when the rate of writes to write buffer 245 exceeds the rate at which write buffer 245 is being drained. It should be noted that although the example of FIG. 1 shows a write buffer used in conjunction with the L1 cache, such write buffers may also be implemented at any level of a cached memory system, and all such implementations are intended to be within the scope of the present disclosure.

Referring back to the example of FIG. 1, the software 135 being executed by the host 105 includes code capable of providing information regarding the operation of the target 110. For example, the software 135 provides information to a user of the host 105 regarding the operation of the circuitry 145, including stall monitoring.

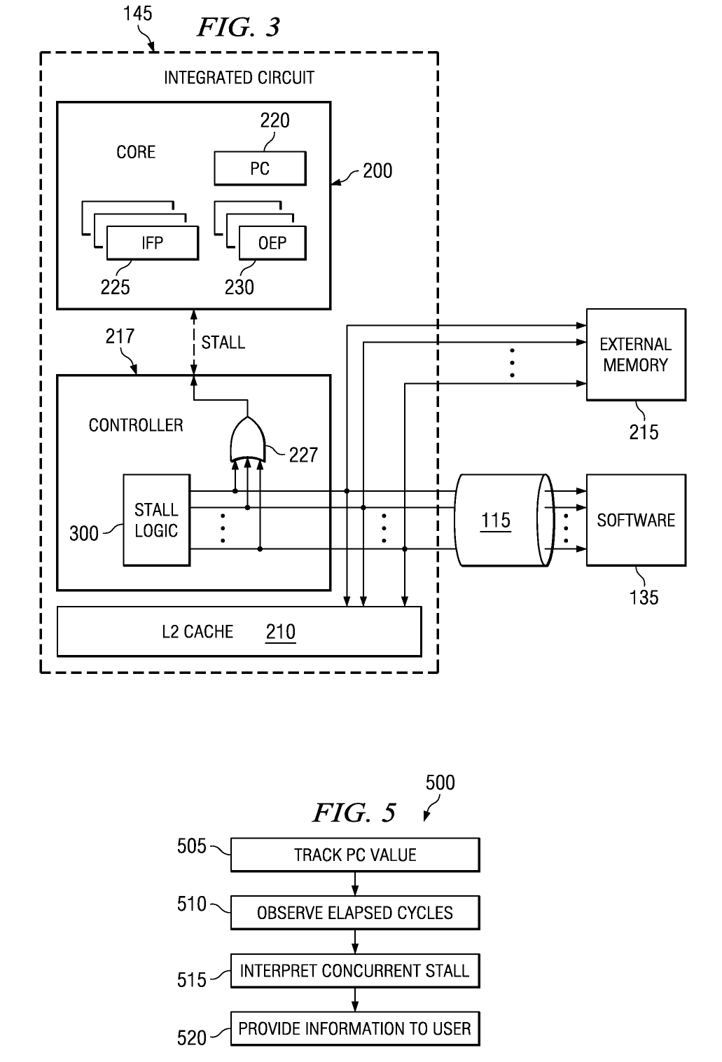

Each memory controller 217, 218, and 219 preferably asserts a stall signal to the core 200 when a stall condition occurs with respect to the associated controller. The stall signals notify the core 200 that more than one cycle is required to perform the requested action. FIG. 3 depicts hardware that is used to provide stall signals that are associated with a specific stall condition, i.e., custom stall signals. These custom stall signals may be provided internally to the circuitry 145 or externally to the software 135 as well as to locations both on and off the circuitry 145. For example, in some embodiments the custom stall signals are processed within the circuitry 145 prior to exporting the custom stall signals off chip. This may be particularly useful if the connection 115 between the circuitry 145 and the software 135 is of limited bandwidth, for example, when the number of pins on the circuitry 145 is limited. In other embodiments, the custom stall signals are provided to the software 135 without processing by the circuitry 145.

As illustrated in FIG. 3, the L1 controller 217 includes stall logic 300 capable of generating these custom stall signals. The custom stall signals are derived based upon the internal states of the respective cache controllers (217 and 218), and from handshake signals of the internal busses of IC 145, such as busy and ready signals (not shown). At least one or all of the other controllers 218 and 219 also may comprise stall logic and thus are capable of generating custom stall signals. Table 1 includes a non-exhaustive list of exemplary custom stall signals and their associated stall event that may cause the particular stall signal to be asserted. These stall signals may be logically combined, for example logically OR'ed by OR gate 227 as illustrated in FIG. 3, to produce the core's composite stall signal.

TABLE 1

| Custom Stall Signal | Associated Stall Event |
|---|---|
| Bank Conflict | Asserted while a simultaneous access to |
| | the same memory bank is being arbitrated. |
| Cache Write/Read Miss | Asserted while cache miss is being |
| | serviced. |
| Write Buffer Full | Asserted on a write miss while the write |
| (The write buffer stores | buffer is full. |
| cache lines that are to | |
| be written back to | |
| external memory.) | |
| Victim Buffer Flush | Asserted during a read miss while the |
| (The victim buffer holds | victim buffer is non-empty. |
| evicted dirty cache lines | |
| that are waiting write | |
| back to external memory.) | |
| Core-Snoop Access | Asserted while a simultaneous access by |
| Conflict | the CPU and by a snoop is being arbitrated. |
| Cache Coherence | Asserted while a simultaneous access by |
| Conflict | the CPU and by a coherence operation is |
| | being arbitrated. |

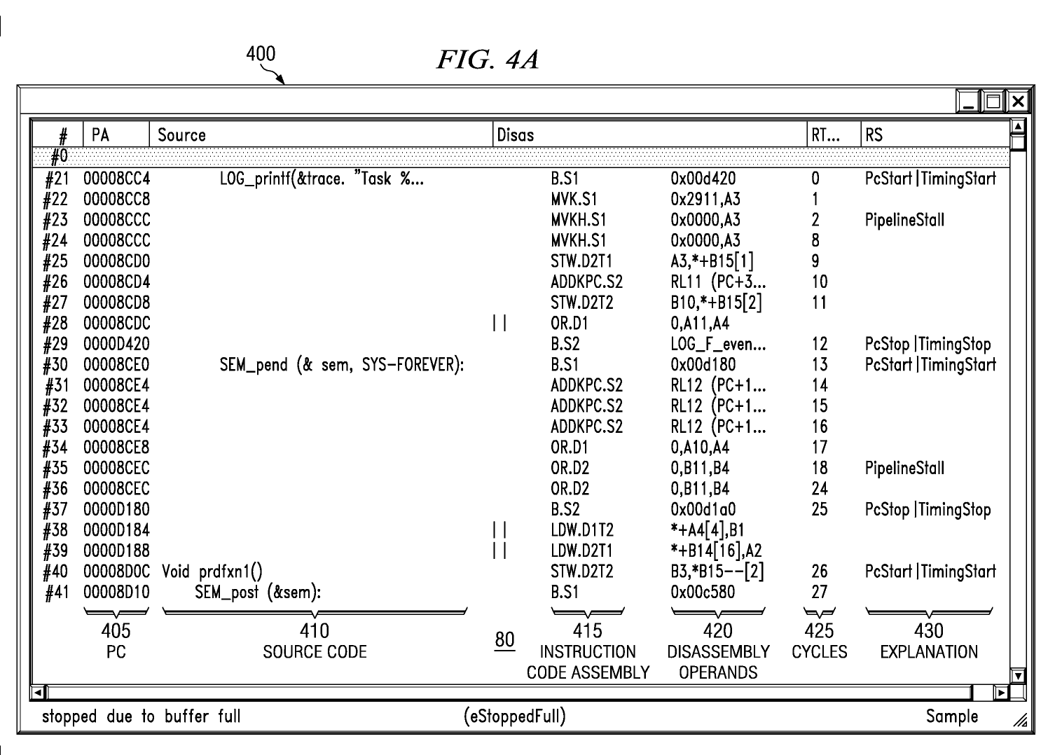

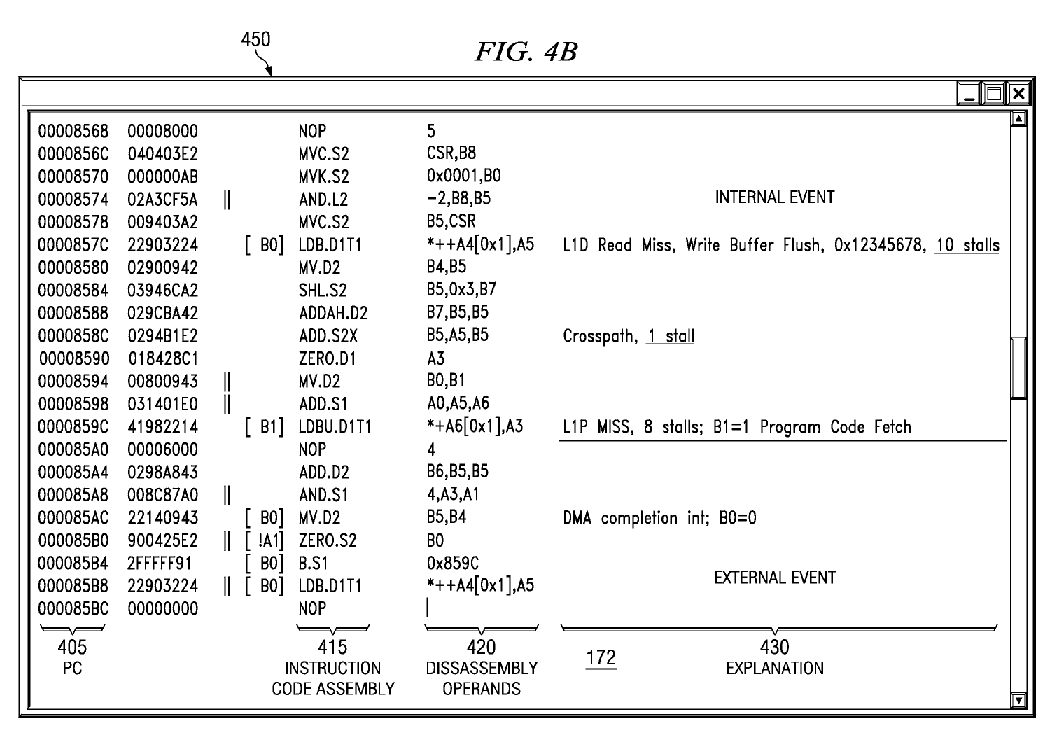

With the custom stall signals, the software 135 or firmware within the circuitry 145 may reveal previously unavailable information regarding the applications being executed on the circuitry 145. This now available information may be used to optimize the applications running on the circuitry 145, especially with respect to stall optimization. FIGS. 4A and 4B depict exemplary output from the software 135 FIG. 4A shows an output without custom stall information available while FIG. 4B shows an output with custom stall information available. In some embodiments, the output shown in FIGS. 4A and 4B are the result of the software 135. Referring first to FIG. 4A, a sequencing 400 is shown divided into various columns 405-430. Column 405 includes a listing of the PC 220 in ascending order (in hex) from top to bottom. Column 410 includes a listing of the source code of the application, which may be in ANSI C, C++, or any other high level programming language. Column 415 includes a listing of the assembly language opcodes that correspond to the high level programming instruction listed in column 410. Column 420 includes a listing of the operands for each opcode in column 415. Column 425 includes a listing of the number of clock cycles that have elapsed at the completion of each assembly language opcode in column 415. Lastly, column 430 includes an explanation of the state of the core 200.

It is desirable for a pipelined system to execute each opcode in a single clock cycle. To that end, stalls should be reduced or eliminated. Stalls may be recognized from inspection of the number of clock cycles in column 425 for each opcode and from inspection of the explanation of the state of the core 200 in column 430. For example, note that at PC equal to 8CCCh the MVKH.S1 opcode, which moves bits into the specified register (S1), consumes 6 cycles and the stall is explained in column 430 as a simply a pipeline stall. Without the embodiments described herein, an application developer trying to optimize the code, however, has no other information as to why the stall actually occurred, only the general explanation given in column 430. In fact, the root cause of this particular pipeline stall may be any number of reasons including program cache miss, wait states, DMA access, to name just a few. Furthermore, if two stalls happen concurrently or sequentially, then the application developer may not be able to distinguish the two separate stall reasons from each other because they may appear as a single system stall.

FIG. 4B depicts a sequencing 450 with columns 405, 415, 420, and 430 for the PC, assembly language code, operands and explanation of the state of the core respectively. However, the explanation 430 from the sequencing 450 also includes custom stall signals that may be available as a result of implementing the exemplary controller 217 shown in FIG. 3. For example, at PC equal to 857Ch the LDB.D1T1 instruction causes a stall as indicated by the text “10 stalls” in column 430, which means that the stall consumed ten cycles. Based on the custom stall signals from the controller 217 the explanation in column 430 elaborates on this stall to indicate that the stall occurred because of a read miss (indicated by the abbreviation “RM”) in the L1D cache and because of a write buffer (indicated by the abbreviation “WB”) flush and that the combined stall duration due to both the read miss and the write buffer flush total ten clock cycles. As is illustrated, some embodiments may include providing the user with the data address of the conflict, which in this case is 0x12345678. With this information known, the application developer may then know the root cause of the stall and be able to more efficiently optimize the code.

FIG. 5 depicts an exemplary algorithm 500 that includes operations that may be executed during debug operations. Referring briefly back to FIG. 1, the algorithm 500 may be executed by the software 135, or alternatively, the algorithm 500 may be executed by firmware (not specifically shown) that is executing on the circuitry 145.

Referring now to FIG. 5, in block 505 the value for the PC 220 may be tracked and displayed in tabular format as illustrated in column 405. The number of elapsed cycles is then observed, in block 510. In at least some embodiments, if the instruction consumes more than a single cycle, then a stall has occurred. In other embodiments, where an instruction may execute an implicit multi-cycle no-operation (or NOOP), a stall is identified where the total duration of the instruction exceeds the number of cycles that is associated with a single, unimpeded execution of the instruction. In block 515, a concurrent stall signal, for example as provided by stall logic 300 (shown in FIG. 3), may be interpreted to determine whether two or more distinct stall conditions have occurred simultaneously. The stall information then may be provided to the user, per block 520, so that the user may be more informed regarding stalls that occurred simultaneously. For example, the user may be informed that the stall is due to both a read miss and a write buffer flush in addition to other details such as how long each separate stall condition lasted. In this manner, the user may be able to debug code that is executing on the circuitry 145 more efficiently because the user may now know how many cycles within a stall are attributable to certain actions and the code accordingly.

The above discussion is meant to be illustrative of the principles and various embodiments of the present invention. Numerous variations and modifications will become apparent to those skilled in the art once the above disclosure is fully appreciated. For example, the electronic device may be coupled to peripheral devices (e.g., external memory, video screens, storage devices), and these peripheral devices may induce stalls so that stall logic 300 also may generate custom stall signals that are based on peripheral induced stalls. Similarly, a coprocessor may be coupled to, or included within, integrated circuit 145 of FIG. 1 (not shown), and the coprocessor may induce stalls so that stall logic 300 also may generate stall signals that are based on these coprocessor induced stalls. Such coprocessor induced stalls may include register crossbar stalls, data ordering stalls, and coprocessor busy stalls. It is intended that the following claims be interpreted to embrace all such variations and modifications.

What is claimed is:

1. A stall monitoring system comprising:
a core integrated on a substrate; and
a stall circuit located on the substrate and coupled to the core, wherein the stall circuit is capable of separately representing at least two distinct stall conditions that occur simultaneously, and wherein the stall circuit makes the separate representations available to locations outside the substrate.

2. The stall monitoring system of claim 1, wherein the stall circuit is part of a memory controller.

3. The stall monitoring system of claim 1, wherein one of the at least two distinct stalls is induced by the core.

4. The stall monitoring system of claim 1, wherein one of the at least two distinct stalls is induced by a memory.

5. The stall monitoring system of claim 1, wherein one of the at least two distinct stalls is induced by a condition selected from the group consisting of a bank conflict, a cache miss, a victim buffer flush, a core-snoop access conflict, and a cache coherence conflict.

6. The stall monitoring system of claim 1, further comprising a write buffer, wherein the write buffer is full and causes the core to stall.

7. The stall monitoring system of claim 1, further comprising a peripheral device coupled to the stall monitoring system, wherein one of the at least two distinct stalls is induced by the peripheral device.

8. The stall monitoring system of claim 1, further comprising a computer program coupled to the stall monitoring system, wherein the computer program provides information regarding the number of stall cycles consumed by each of the distinct stall conditions.

9. The stall monitoring system of claim 1, further comprising a computer program coupled to the stall monitoring system, wherein the computer program interprets the at least two distinct stall signals and conveys this interpretation to a user.

10. The stall monitoring system of claim 1, wherein the at least two distinct stall signals are chosen from the group consisting of a bank conflict, a cache miss, a write buffer full, a victim buffer flush, a core-snoop access conflict, and a cache coherence conflict.

11. The stall monitoring system of claim 1, further comprising a coprocessor coupled to the core, wherein the stall circuit is part of the coprocessor.

12. The stall monitoring system of claim 11, wherein one of the at least two distinct stalls is induced by the coprocessor.

13. The stall monitoring system of claim 12, wherein the at least two distinct stall signals are chosen from the group consisting of a register crossbar stall, a data ordering stall, and a coprocessor busy stall.

14. A method of monitoring stall cycles comprising:
tracking a program counter (PC) value associated with an instruction that has been executed;
observing a number of elapsed cycles at the conclusion of the instruction's execution, wherein a stall occurs if the instruction's execution consumed more than the number of cycles associated with a single, unimpeded execution of the instruction; and
interpreting a concurrent stall signal if a stall has occurred, wherein the concurrent stall signal is capable of separately representing at least two distinct stall conditions that occur simultaneously.

15. The method of claim 14, further comprising providing information to a user regarding distinct stall conditions that occur simultaneously.

16. The method of claim 15, wherein the at least two distinct stall signals are chosen from the group consisting of a bank conflict, a cache miss, a write buffer full, a victim buffer flush, a core-snoop access conflict, a cache coherence conflict, a register crossbar stall, a data ordering stall, and a coprocessor busy stall.

17. The method of claim 15, further comprising providing information regarding the number of stall cycles consumed by each of the distinct stall conditions.

18. The method of claim 15, further comprising providing the instruction that was executed for each PC value.

19. The method of claim 14, wherein one of the at least two distinct stall conditions that occur simultaneously is induced by a core executing the instruction.

20. The method of claim 19, wherein one of the at least two distinct stall conditions that occur simultaneously is induced by a memory coupled to the core.

21. The method of claim 19, wherein one of the at least two distinct stall conditions that occur simultaneously is induced by a peripheral device coupled to the core.

22. The method of claim 19, wherein one of the at least two distinct stall conditions that occur simultaneously is induced by a coprocessor coupled to the core.

23. A computer program embodied in a tangible medium, the instructions of the program comprising the acts of:
tracking a value for a program counter (PC) of a processor executing instructions;
observing a number of elapsed cycles by the processor;
interpreting a plurality of concurrent stall signals; and
providing a user with information regarding at least two distinct stall conditions that occur.

24. The computer program of claim 23, wherein the at least two distinct stall conditions occur simultaneously.

25. The computer program of claim 23, wherein the at least two distinct stall signals are chosen from the group consisting of a bank conflict, a cache miss, a write buffer full, a victim buffer flush, a core-snoop access conflict, and a cache coherence conflict.

26. The computer program of claim 23, further comprising providing information regarding the number of stall cycles consumed by each of the distinct stall conditions.

27. The computer program of claim 23, further comprising providing the instruction that was executed for each PC value.

28. The computer program of claim 23, wherein one of the at least two distinct stall conditions that occur simultaneously is induced by a core executing the instruction.

29. The computer program of claim 28, wherein one of the at least two distinct stall conditions that occur simultaneously is induced by a coprocessor coupled to the core.

30. The computer program of claim 28, wherein one of the at least two distinct stall conditions that occur simultaneously is induced by a memory coupled to the core.

31. The computer program of claim 28, wherein one of the at least two distinct stall conditions that occur simultaneously is induced by a peripheral device coupled to the core.

32. A stall circuit capable of interfacing with a core, wherein the stall circuit represents at least two distinct stall conditions that occur simultaneously within the core, and wherein the stall circuit is capable of providing separate representations of the at least two distinct stall conditions to locations other than the core.

33. The stall circuit of claim 32, wherein the stall circuit is part of a memory controller.

34. The stall circuit of claim 32, wherein one of the at least two distinct stalls is induced by the core.

35. The stall circuit of claim 32, wherein one of the at least two distinct stalls is induced by a memory.

35. The stall circuit of claim 32, wherein the stall circuit is coupled to a write buffer and wherein one of the at least two distinct stalls is induced by the write buffer.

36. The stall circuit of claim 32, wherein a peripheral device is coupled to the stall circuit and wherein one of the at least two distinct stalls is induced by the peripheral device.

37. The stall circuit of claim 32, wherein a coprocessor is coupled to the stall circuit and wherein one of the at least two distinct stalls is induced by the coprocessor.

38. The stall circuit of claim 32, wherein a computer program is coupled to the stall circuit and wherein the computer provides information regarding the number of stall cycles consumed by each of the distinct stall conditions.

39. The stall circuit of claim 32, wherein a computer program is coupled to the stall circuit and wherein the computer program interprets the at least two distinct stall signals and conveys this interpretation to a user.

40. The stall circuit of claim 32, wherein the at least two distinct stall signals are chosen from the group consisting of a bank conflict, a cache miss, a write buffer full, a victim buffer flush, a core-snoop access conflict, and a cache coherence conflict.
